(19) United States
(12) Patent Application Publication
(10) Pub. No.: US 2024/0366015 A1
(43) Pub. Date: Nov. 7, 2024

(54) KITCHEN APPLIANCE

(71) Applicant: David Benzakarya, Los Angeles, CA (US)

(72) Inventor: David Benzakarya, Los Angeles, CA (US)

(21) Appl. No.: 18/142,999

(22) Filed: May 3, 2023

(51) Int. Cl. A47J 19/00; A47J 43/28

(52) U.S. Cl. CPC A47J 19/005; A47J 43/287; A47J 27/04; A47J 43/14; A47J 47/16

(57) ABSTRACT

A kitchen appliance made of metal which can be aluminum, stainless steel or copper. The diameter is between 3.5-5.5 inches with a height between 2-3 inches. The base has a plurality of holes, each hole measuring between 1/32-¼ inches in diameter. The appliance has a dull and simple finish, is small, lightweight and easy to store. It is useable for the following functions: a container for holding food, particularly cut fruits, grains and the like; a steamer; a strainer (grains lentils, pasta and the like); a food server; a separator for egg yoks from egg whites; a spoon rest; ad a cup base or cup holder.

### BACKGROUND OF THE INVENTION

### Field of the Invention

The field of this invention relates generally to the field of household appliances and more particularly toward a food container for use in the kitchen.

### Description of the Prior Art

There are so many kitchen gadgets made to contain and/or store food. Some have only one specific purpose and therefore its function is very limited. The instant invention provides for a kitchen appliance with a versatile design for multiple applications. The device of the instant invention combines several uses for a single container. The device is a reduce size which makes it a space saver, thereby providing for a more organized and clutter-free kitchen.

It is the object of the instant invention to provide a kitchen appliance with the following functions: a container for holding food, particularly cut fruits, grains and the like; a steamer; a strainer (grains lentils, pasta and the like); a food server; a separator for egg yoks from egg whites; a spoon rest; ad a cup base or cup holder.

### SUMMARY OF THE INVENTION

The basic embodiment of the present invention teaches a versatile, multi-purpose kitchen appliance comprising: a circular base; a cylindrical sidewall extending upward from said circular base; a plurality of apertures in said circular base; and one or more notches at a top of said cylindrical sidewall.

The above embodiment can be further modified by defining that said one or more notches includes two or more that are spaced equidistance apart.

The above embodiment can be further modified by defining that said circular base has a tapered bottom such that said diameter of said circular base is decreased to a size less than a diameter of a top of said cylindrical sidewall.

The above embodiment can be further modified by defining that said circular base has a diameter between 3.5 and 5.5 inches.

The above embodiment can be further modified by defining that said circular base has a diameter of 4.25 inches.

The above embodiment can be further modified by defining that said cylindrical sidewall has a height between 2-3 inches.

The above embodiment can be further modified by defining that said cylindrical sidewall has a height of 2 7/32 inches.

The above embodiment can be further modified by defining that each of said plurality of holes in said circular base have a diameter between 1/32 and ¼ inches.

The above embodiment can be further modified by defining that each of said plurality of holes in said circular base has a diameter of ⅛.

### BRIEF DESCRIPTION OF THE DRAWINGS

For a better understanding of the present invention, reference is to be made to the accompanying drawings. It is to be understood that the present invention is not limited to the precise arrangement shown in the drawings.

FIG. 1 is a top view of the kitchen appliance of the instant invention.

FIG. 2 is a front view of the kitchen appliance of the instant invention.

FIG. 3 is a bottom view of the kitchen appliance of the instant invention.

FIG. 4 is a taken along the line A-A in FIG. 2.

FIG. 5 is an isometric view of the kitchen appliance of the instant invention with a cutout section.

FIG. 6 is an isometric view of the kitchen appliance of the instant invention without a cutout section.

FIG. 7 is another bottom view of the kitchen appliance of the instant invention.

FIG. 8 is a side view taken along line B-B in FIG. 7.

FIG. 9 is a bottom view taken along line A-A in FIG. 2.

FIG. 10 is a top view of the kitchen appliance of the instant invention.

FIG. 11 is a front view of the kitchen appliance of the instant invention.

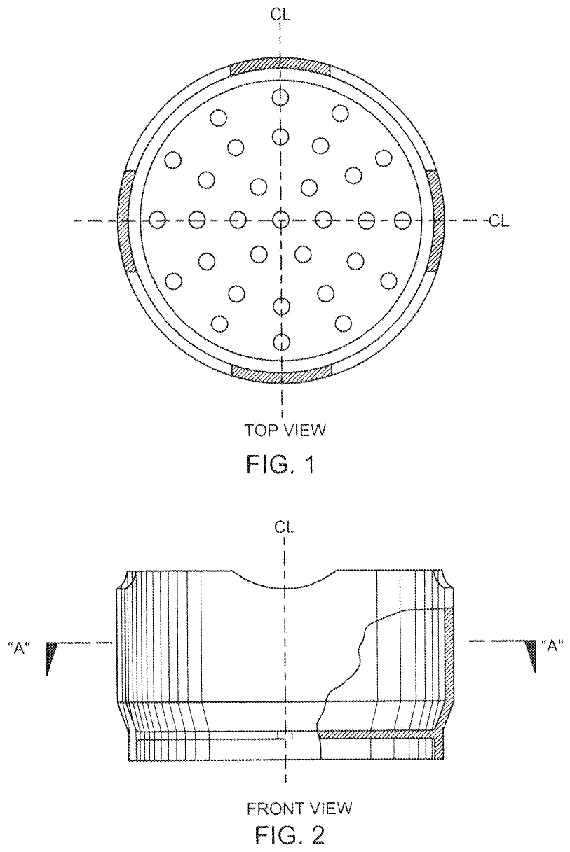

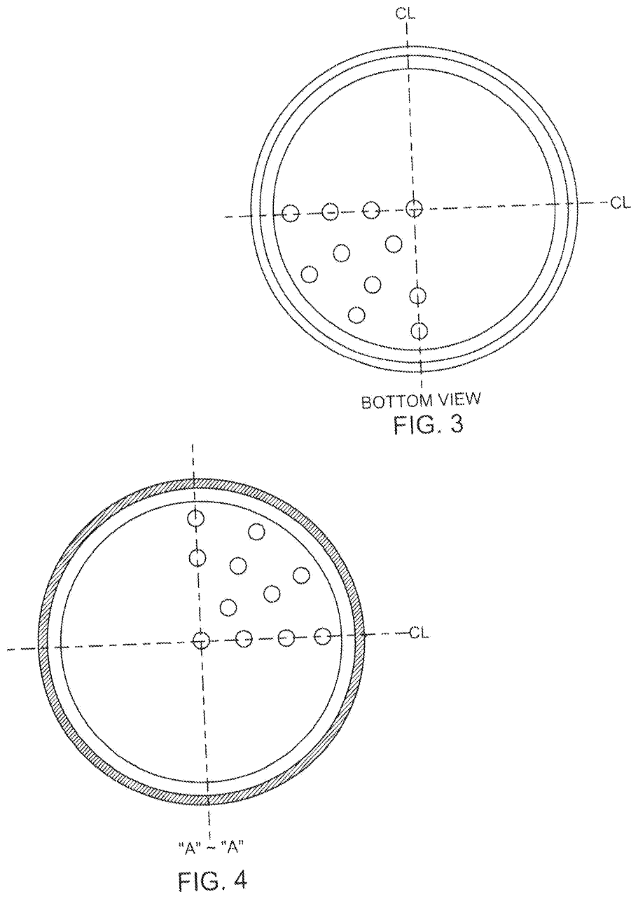

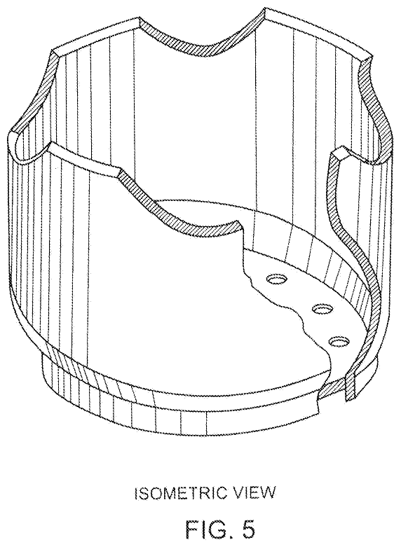

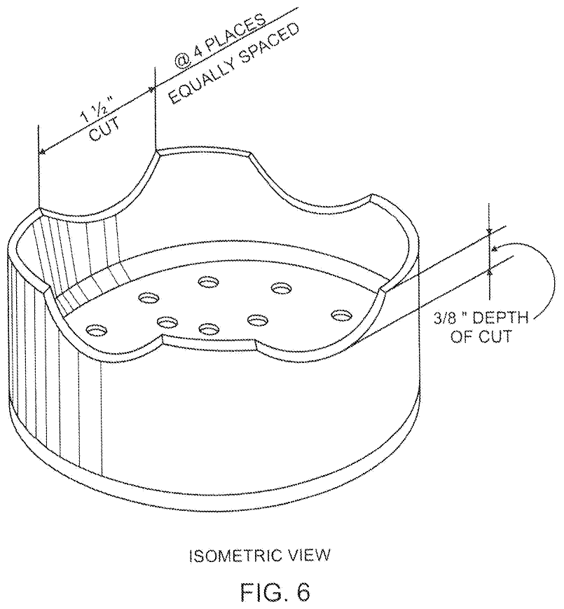

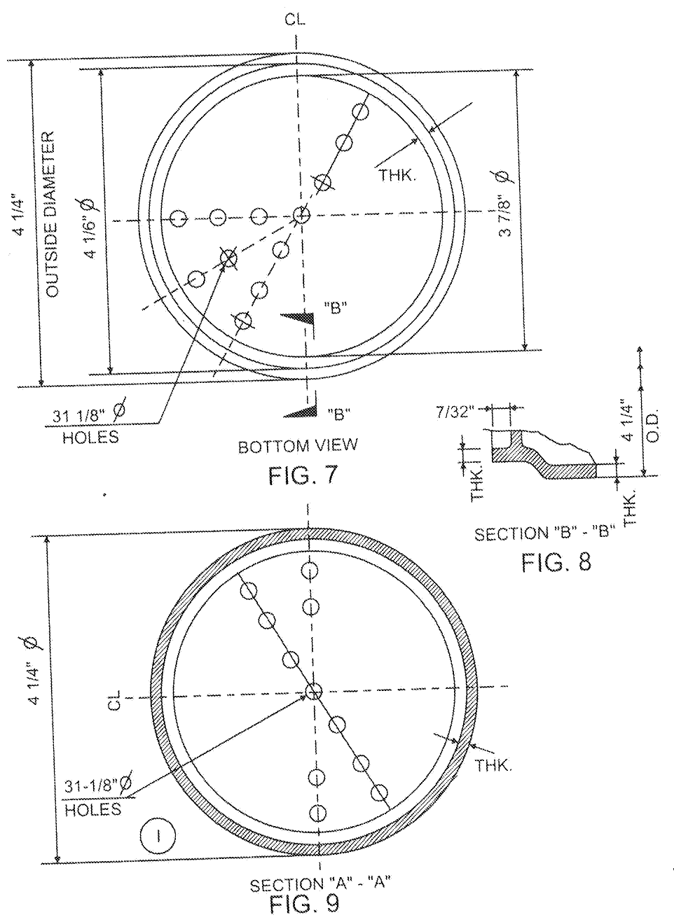

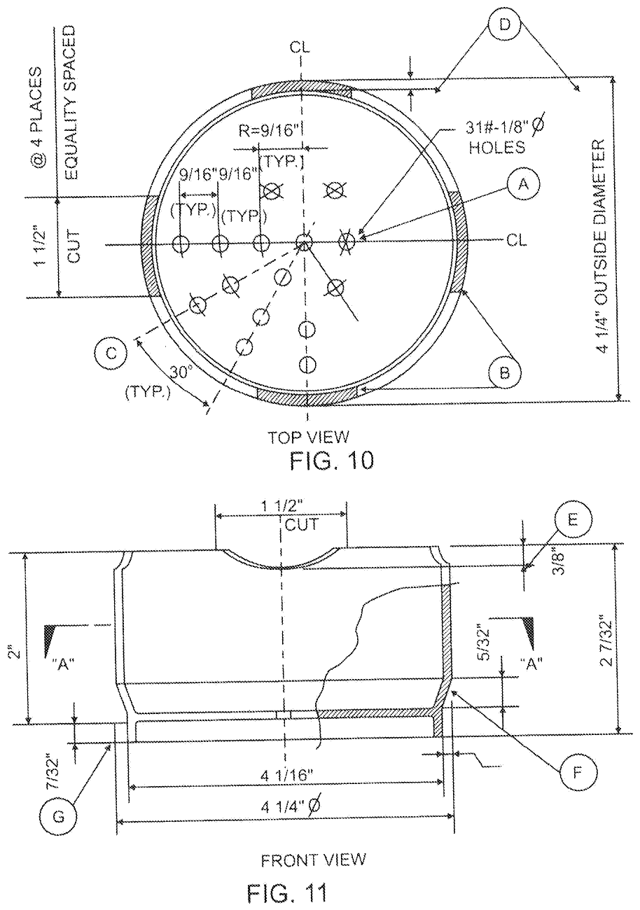

### DETAILED DESCRIPTION OF A PREFERRED EMBODIMENT

Turning to the drawings, the preferred embodiment is illustrated and described by reference characters that denote similar elements throughout the several views of the instant invention.

The preferred embodiment of the instant invention provides for a kitchen appliance with an outside diameter between 3.5-55 inches, preferably 4¼ inches and a height between 2-3 inches, preferably 2 7/32 inches. The device has a plurality of holes at the bottom, each hole measuring between 1/32-¼″, preferably ⅛″. The plurality of holes will serve as the steam vent or drain holes, depending on the use. Notches are provided at the top of the unit which can serve as a spoon rest. These four equally-spaced notches measure between 1-2 inches in length, preferably 1½ with a depth between ¼ to ½ inch, preferably ⅜″.

The bottom of the unit has a taper between ¼″ and 5/16″, preferably 7/32″. This tapering makes the bottom between 4-4½″ in diameter, preferably 4 1/16″, which is a little bit less than the top diameter.

The device is made of metal, preferably aluminum which is a good conductor of heat and very lightweight.

The kitchen appliance is configured as a small food container with several other functions. It can not only hold food and small utensils, but is also a small and lightweight, convenient kitchen helper and organizer. Located on its side are four shallow decorative cuts or notches which can serve as a spoon rest. The bottom contains holes for draining water from food, such as pasta, grains or lentils. It also useable as a steam vent when steaming food as well as a separator for egg yolks from egg whites.

The size of the unit, measuring preferably 4½″ in diameter is wide enough to accommodate mugs or glasses serving as a base or holder. When used as a holder, it is not only for protecting the fragile glass base but will also add to the aesthetics.

The device includes a bottom/base with a plurality of holes A. The plurality of holes A allows for straining and steaming applications. The plurality of holes A are oriented in groups in 30 degree angles C. The base has an internal diameter and an outer diameter D, the difference being the thickness of the sidewall which is oriented upward from the base in a cylindrical shape that has a series of notches B. These notches B are cut to a depth E to provide a space to hold a spoon or just to provide decorative sides when the device is used as a cup or mug holder/stand. There is a taper G at the base that modifies the diameter of the base relative to the open top.

The invention illustratively disclosed herein suitably may be practiced in the absence of any element which is not specifically disclosed herein.

The discussion included in this detailed description is intended to serve as a basic description. The reader should be aware that the specific discussion may not explicitly describe all embodiments possible and alternatives are implicit. Also, this discussion may not fully explain the generic nature of the invention and may not explicitly show how each feature or element can actually be representative or equivalent elements. Again, these are implicitly included in this disclosure. Where the invention is described in device-oriented terminology, each element of the device implicitly performs a function. It should also be understood that a variety of changes may be made without departing from the essence of the invention. Such changes are also implicitly included in the description. These changes still fall within the scope of this invention.

Further, each of the various elements of the invention and claims may also be achieved in a variety of manners. This disclosure should be understood to encompass each such variation, be it a variation of any apparatus embodiment, a method embodiment, or even merely a variation of any element of these. Particularly, it should be understood that as the disclosure relates to elements of the invention, the words for each element may be expressed by equivalent apparatus terms even if only the function or result is the same. Such equivalent, broader, or even more generic terms should be considered to be encompassed in the description of each element or action. Such terms can be substituted where desired to make explicit the implicitly broad coverage to which this invention is entitled. It should be understood that all actions may be expressed as a means for taking that action or as an element which causes that action. Similarly, each physical element disclosed should be understood to encompass a disclosure of the action which that physical element facilitates. Such changes and alternative terms are to be understood to be explicitly included in the description.

What is claimed is:

1. A versatile, multi-purpose kitchen appliance comprising:
a circular base;
a cylindrical sidewall extending upward from said circular base;
a plurality of apertures in said circular base; and
one or more notches at a top of said cylindrical sidewall.

2. The versatile, multi-purpose kitchen appliance as defined in claim 1 wherein said one or more notches includes two or more that are spaced equidistance apart.

3. The versatile, multi-purpose kitchen appliance as defined in claim 1 wherein said circular base has a tapered bottom such that said diameter of said circular base is decreased to a size less than a diameter of a top of said cylindrical sidewall.

4. The versatile, multi-purpose kitchen appliance as defined in claim 1 wherein said circular base has a diameter between 3.5 and 5.5 inches.

5. The versatile, multi-purpose kitchen appliance as defined in claim 4 wherein said circular base has a diameter of 4.25 inches.

6. The versatile, multi-purpose kitchen appliance as defined in claim 1 wherein said cylindrical sidewall has a height between 2-3 inches.

7. The versatile, multi-purpose kitchen appliance as defined in claim 6 wherein said cylindrical sidewall has a height of 2 7/32 inches.

8. The versatile, multi-purpose kitchen appliance as defined in claim 1 wherein each of said plurality of holes in said circular base have a diameter between 1/32 and ¼ inches.

9. The versatile, multi-purpose kitchen appliance as defined in claim 8 wherein each of said plurality of holes in said circular base has a diameter of ⅛″.
